(19) United States
(12) Patent Application Publication
(10) Pub. No.: US 2015/0144849 A1
(43) Pub. Date: May 28, 2015

(54) COMPOSITE COPPER PARTICLES, AND METHOD FOR PRODUCING SAME

(71) Applicant: Mitsui Mining & Smelting Co., Ltd., Tokyo (JP)

(72) Inventors: Toshihiro Kohira, Yamaguchi (JP); Takafumi Sasaki, Yamaguchi (JP); Shinji Aoki, Yamaguchi (JP); Takahiko Sakaue, Yamaguchi (JP)

(73) Assignee: Mitsui Mining & Smelting Co., Ltd., Tokyo (JP)

(21) Appl. No.: 14/412,734

(22) PCT Filed: Jun. 19, 2013
(86) PCT No.: PCT/JP2013/066871

§ 371 Date: Jan. 5, 2015

(30) Foreign Application Priority Data
Jul. 6, 2012 (JP) 2012-152956

(51) Int. Cl. H01B 1/02; H01B 13/00; H01B 1/22

(52) U.S. Cl. CPC H01B 1/026; H01B 1/22; H01B 13/0026
USPC 252/512; 428/570; 427/126.1

(57) ABSTRACT

The disclosed composite copper particle includes a core particle including copper, and a coating layer including a copper-tin alloy and formed on the surface of the core particle, the composite copper particle having a particle diameter at 50% cumulative volume in the particle size distribution of 0.1 to 10.0 μm. The alloy is preferably CuSn. The ratio of tin to the the composite copper particle is preferably 3.0 to 12.0 mass %. The composite copper particle is suitably obtained by a method including a step of mixing a reducing agent for tin and an aqueous slurry containing a tin source compound and core particles which include copper, to form a coating layer including a copper-tin alloy on a surface of the core particles.

### TECHNICAL FIELD

This invention relates to a composite copper particle having a coating layer of a copper-tin alloy on its surface and a method for producing the same.

### BACKGROUND ART

Having high electrical conductivity, copper is useful as a conductor material providing an electrical path between electrodes. Copper is supplied in the form of, e.g., conductive powder or a conductive paste prepared with a vehicle for use to form microwires by screen printing, dispensing, inkjet printing, or a like technique. To achieve micro wiring, it is advantageous to use copper particles with a small particle size. However, because copper is susceptible to oxidation, reduction in copper particle size is accompanied by acceleration of oxidation, resulting in reduction of conductivity. Then, copper particles with increased oxidation resistance have been proposed.

For example, Patent Literature 1 below proposes tin-coated copper particles each comprising a copper core particle and a tin coating layer. The tin-coated copper particles have an average particle size of 0.1 to 5 μm and 5 to 40 mass % of the tin coating layer. They are produced by mixing an aqueous slurry, in which copper particles are dispersed, and a tin solution containing a tin salt and thiourea thereby to deposit tin by displacement, precipitation on the surface of the copper particles.

Patent Literature 2 below proposes copper particles containing 0.07 to 10 at % of aluminum and 0.01 to 0.3 at % of phosphorus in the inside thereof. The copper particles are produced by an atomizing method. Patent Literature 2 mentions that incorporating a specific amount of aluminum into copper particles allows for a good balance between oxidation resistance and conductivity of copper particles.

### CITATION LIST

### Patent Literature

Patent Literature 1: JP 2006-225691A

Patent Literature 2: US 2011/031448 A1

### SUMMARY OF INVENTION

While the techniques described in the literature cited above succeed in improving oxidation resistance, there still has been a demand for further improvement in oxidation resistance in good balance with conductivity. Accordingly, it is an object of the invention to provide copper particles with further improved performance properties over those achieved by the conventional techniques.

The invention provides a composite copper particle including a core particle including copper, and a coating layer including a copper-tin alloy and formed on the surface of the core particle, the composite copper particle having a particle diameter at 50% cumulative volume in the particle size distribution of 0.1 to 1.0.0 μm.

The invention provides a suitable method for producing the aforementioned, composite copper particles including a step of mixing a reducing agent for tin and an aqueous slurry containing a tin source compound and core particles which include copper, to form a coating layer comprising a copper-tin alloy on a surface of the core particles.

### BRIEF DESCRIPTION OF DRAWINGS

FIG. 1 is an XRD pattern of the composite copper particles obtained in Example 1.

FIG. 2 is a graph showing the results of differential thermal analysis (DTA) of the copper particles obtained in Examples and Comparative Examples.

FIG. 3 is a graph showing the results of thermogravimetry (TG) of the copper particles obtained in Examples and Comparative Examples.

### DESCRIPTION OF EMBODIMENTS

The composite copper particle of the invention comprises a copper core particle and a coating layer covering the surface of the core particle. The coating layer is composed of an alloy of copper and tin. While the copper particle according to the conventional technique is coated with a tin coating layer, it has been unexpectedly found that replacing tin of the coating layer with a copper-tin alloy allows for further improvement in oxidation resistance and low electrical resistance even at high temperatures.

The oxidation resistance of the composite copper particles of the invention may be evaluated by the temperature at which a exothermic peak, which is measured by, for example, differential thermal analysis, ascribed to oxidation of copper is observed. In detail the composite copper particles of the invention show an exothermic peak ascribed to oxidation of copper preferably at 450° C. or higher, more preferably at 500° C. or higher, in differential thermal analysis conducted in the atmosphere at a rate of temperature rise of 10° C./min.

Known copper-tin alloys include those having compositions such as CuSn, Cu₃Sn, Cu₆Sn₅, Cu_{6.25}Sn₅, Cu₃₉Sn₁₁, and Cu_{40.5}Sn₁₁. One or more of these alloys may be used in the invention. To obtain high oxidation resistance and low electrical resistance even at high temperatures, it is preferred to use at least one of CuSn alloy, Cu₆Sn₅ alloy, and Cu₃Sn alloy, particularly CuSn alloy.

The copper-tin alloy exists on and in the vicinity of the surface of the composite copper particles of the invention. The inside of the composite copper particle is composed substantially solely of copper, and tin is substantially absent in the inside of the composite copper. Metal elements other than tin and other nonmetal elements are also substantially absent in the inside of the composite copper. The phrase “substantially absent” is intended to preclude intentional incorporation of an element other than copper. It is permitted that a trace amount of an element other than copper is unavoidably incorporated during the method for manufacturing the composite copper particles.

In order to sufficiently improve the oxidation resistance, it is preferred that the copper-tin alloy coating layer cover the core particle with a thickness of 5.0 to 500.0 nm, more preferably 40.0 to 200.0 nm. The thickness of the coating layer is adjustable by properly selecting the conditions for reductive plating in the manufacture of the composite copper particles by the process hereinafter described. The thickness of the coating layer is measured by, for example, observing a cross-section of the particle using an SEM or an SEM-EDS.

The tin to copper atomic ratio in the coating layer may be constant or gradually change in the thickness direction. It is preferred that the copper ratio gradually increase toward the core particle in the vicinity of the boundary between the coating layer and the core particle. In that case, the coating layer has good affinity to the core particle and is less likely to come off. A coating layer having such a copper ratio gradation may be formed by the method described infra.

The ratio of tin to the total mass of the composite copper particle is preferably 1.0 to 50.0 mass %, more preferably 2.0 to 25.0 mass %, even more preferably 2.5 to 15.0 mass %. The ratio of copper to the total mass of the composite copper particle is preferably 50.0 to 99.0 mass %, more preferably 75.0 to 98.0 mass %, even more preferably 85.0 to 97.5 mass %. In the above recited tin and copper ratios, the composite copper particle exhibits improved oxidation resistance without impairing electroconductivity. At a tin ratio of 1.0 mass % or higher, the composite copper particle has increased heat resistance. At a tin ratio of 50.0 mass % or lower, the composite copper particle has reduced electrical resistance. The tin and copper ratios of the composite copper particles are measured by, for example, dissolving the composite copper particles in an acid (e.g., a mineral acid) and analyzing the solution by ICP.

The composite copper particles preferably have a particle diameter at 50% cumulative volume in the particle size distribution size (hereinafter, referred to as an average particle size D₅₀ or simply D₅₀) of 0.1 to 10.0 μm, more preferably 0.5 to 8.0 μm. With the D₅₀ falling in that range, the composite copper particles will have improved oxidation resistance while securing printability and wire density when used as a microwiring material in electrical circuits or electronic devices. When the D₅₀ is greater than 10.0 μm, the particles have a reduced specific surface area and low likelihood of being oxidized, so that there will be little practical benefit in forming a coating layer. If the D₅₀ is smaller than 0.1 μm, on the other hand, the ratio of tin to the total mass of the composite copper particle tends to increase relatively, making it difficult to secure low electrical resistance.

The composite copper particle may have, for example, a spherical, polyhedral, or flaky shape. The shape of the composite copper particles may be chosen according to the intended use of the particles. For instance, spherical particles are preferred for use in the formation of fine electrical circuits by printing. As stated earlier, since the thickness of the coating layer is much smaller than the particle size of the composite copper particles, the shape of the composite copper particles are not so different from that of the core particles. Therefore, the shape of the core particle is regarded equal to that of the composite copper particle.

The core particles may be produced by a wet process or an atomization process. It is advantageous in terms of production efficiency to use core particles produced by a wet process, taking into consideration that the coating layer is formed by reductive plating as will be described later. The core particles preferably have an average particle size D₅₀ of 0.1 to 10.0 μm, more preferably 0.2 to 5.0 μm.

The composite copper particles preferably have a tap density of 1.0 to 10.0 g/cm³, more preferably 1.5 to 5.0 m³/g. With the tap density in that range, it will be easier to ensure high conductivity when the composite copper particles are used as a microwiring material for electrical circuits and electronic devices. The preferred tap density is obtained by properly selecting the shape of the core copper particles and/or the reductive plating conditions in the formation of the coating layer in the hereinafter described method of producing the composite copper particles. The tap density is measured using, for example, Powder Tester from Hosokawa Micron.

For the same reason of preference for the tap density range, it is preferred for the composite copper particles to have a BET specific surface area of 0.1 to 10.0 m²/g, more preferably 0.2 to 5.0 m²/g. The BET specific surface area is measured using, for example, MonoSorb from Quantachrome Instruments and He/N₂ mixed gas.

A preferred method for producing the composite copper particles of the invention will then be described. The method includes forming a coating layer of a copper-tin alloy on the surface of core particles which include copper by reductive plating. The inventors have unexpectedly found it possible to precipitate an alloy of copper and tin by employing a reductive plating technique. If displacement plating, another plating technique, is adopted, a coating layer made of elemental tin is formed as described in Patent Literature 1.

The formation of a coating layer of a copper-tin alloy on the surface of core particles by reductive plating starts with preparing an aqueous slurry containing core particles and a tin source compound, and a reducing agent for tin. The ratio of the core particles contained in the aqueous slurry is preferably 80.0 to 99.0 mass %, more preferably 88.0 to 97.0 mass %.

The tin source compound contained in the aqueous slurry may be a water soluble compound, such as a water soluble tin complex. Examples of suitable water soluble tin complexes include organic tin (II) sulfonates, e.g., tin (II) methanesulfonate, tin (II) chloride, tin (II) bromide, tin (II) iodide, tin (II) lactate, tin (II) citrate, tin (II) tartrate, tin (II) gluconate, and tin (II) succinate. These compounds may be used either alone or in combination of two or more thereof. The concentration of tin source compound contained in the aqueous slurry is preferably 10⁻³ to 2.0 mol/L, more preferably 10⁻³ to 0.5 mol/L, in terms of tin.

In order to stabilize the tin source in the aqueous slurry, an organic aminocarboxylic acid compound may be added to the slurry. Examples of suitable organic aminocarboxylic acid compounds include ethylenediaminetetraacetic acid, diethylenetriaminepentaacetic acid, hydroxyethyliminodiacetic acid, dihydroxyethyliminoacetic acid, glycine, arginine, glutamine, lysine, and nitrilotriacetic acid. In place of, or in addition to, the organic aminocarboxylic acid compound, an alcohol amine, such as monoethanolamine, diethanolamine, or triethanolamine, may be added. These alcohol amines may be used either individually or in combination of two or more thereof. The concentration (mol/L) of the organic aminocarboxylic acid compound or the alcohol amine contained in the aqueous slurry is preferably 0.1 to 20 times, more preferably 1.0 to 10 times, the concentration of tin (mol/L). When an organic aminocarboxylic acid compound and an alcohol amine are used in combination, it is preferred for the concentration of each of them to be in the range described.

The copper to tin weight ratio in the aqueous slurry is preferably 10.0:0.1 to 10.0:2.0, in terms of preventing precipitation of elemental tin and uniformly forming a tin alloy coat on the surface of copper particles.

The reducing agent for tin (hereinafter referred to as tin-reducing agent or simply reducing agent) to be mixed with the aqueous slurry is a substance having capability of reducing tin ions. In order to successfully form a desired coating layer of a tin-copper alloy, it is particularly preferred to use a reducing agent represented by an oxidation-reduction potential of −900 mV or lower, more preferably −950 mV or lower, even more preferably −1000 mV or lower, at pH 9.0. A reducing agent having such a reducing power is exemplified by sodium boron hydride, potassium boron hydride, and hydrazine. The reducing agent is usually used in the form of an aqueous solution.

In order to achieve successful formation of a desired coating layer, it is preferred to adjust the pH of the aqueous slurry before mixing with the tin-reducing agent. Specifically, the pH of the aqueous slurry has been preferably adjusted to 9.0 to 11.0, more preferably 9.0 to 10.0. The pH adjustment may be effected using, for example, aqueous ammonia, a sodium hydroxide aqueous solution, or a potassium hydroxide aqueous solution.

The mixing of the aqueous slurry and the tin-reducing agent is conducted by adding the reducing agent to the aqueous slurry or, conversely, adding the aqueous slurry to the reducing agent. Taking ease of control of the reduction reaction into consideration, it is preferred to add the reducing agent to the aqueous slurry. In that case, the reducing agent may be added either at one time or continuously or portionwise over a prescribed period of time. Taking ease of reduction reaction control into consideration, successive addition is preferred to one-time addition.

Upon adding the reducing agent, reduction reaction of tin starts, and a copper-tine alloy precipitates on the surface of the core particles. The composition of the alloy is adjustable by controlling the reduction reaction through the adjustment of the ratio of the reducing agent added to the tin present in the aqueous slurry. When a CuSn alloy is desired, it is advantageous to add 1.0 to 10.0 equivalents, preferably 1.0 to 5.0 equivalents, of the reducing agent relative to the tin contained in the aqueous slurry. The aqueous slurry is preferably stirred during the addition of the reducing agent so as to cause a reduction reaction to occur uniformly. The stirring of the aqueous slurry is preferably continued after completion of the addition of the reducing agent.

The composite copper particles obtained by the above described operations are washed by repulping and collected by filtration. Where needed, the resulting solid may be washed with water or methanol or otherwise worked up.

The thus obtained composite copper particles may be mixed with known components such as a vehicle to give a conductive paste. The components of a conductive paste and their compounding ratio are well-known to those skilled in the art. The conductive paste is suitably used to form, for example, microwires of electric circuits or electronic devices. Specifically, the conductive paste may be used in the formation of conductor circuits by an additive screen printing technique. The conductive paste is also useful as various electrical contact members, such as those for an external electrode of a multilayer ceramic capacitor.

### EXAMPLES

The invention will now be illustrated in greater detail with reference to Examples, but it should be understood that the invention is not deemed to be limited thereto. Unless otherwise noted, all the percents are given by mass.

### Example 1

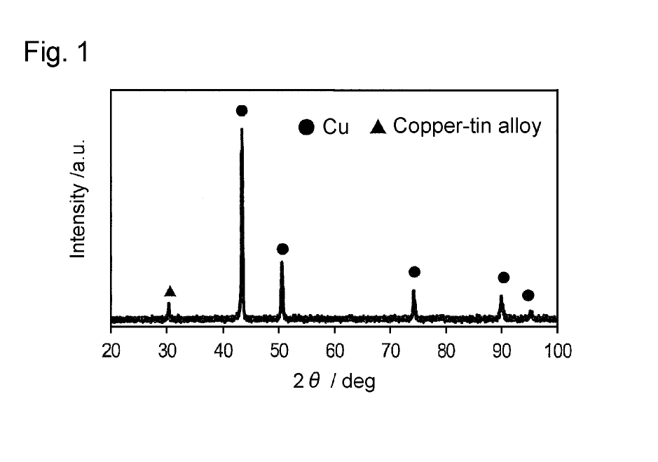

Spherical copper particles produced by a wet process were used as core particles. The core particles had an average particle size D₅₀ of 0.99 μm. In 8.9 L of pure water were dispersed 200 g of the core particles. Tin (II) methanesulfonate as a tin source compound was added to the resulting slurry in an amount of 30 g in terms of tin. Ethylenediaminetetraacetic acid (aminocarboxylic acid) was then added thereto as a stabilizer for the tin source in a concentration equal to that of tin. The mixture was stirred at a liquid temperature of 50° C. to dissolve the tin source compound. The slurry was adjusted to a pH of 9 by adding ammonia. To the resulting aqueous slurry was added an aqueous solution of 14.35 g of sodium boron hydride in 100 ml of water continuously over 10 minutes while stirring. The addition of sodium boron hydride caused a tin-reducing reaction thereby to form a coating layer of a copper-tin alloy on the surface of the copper core particles. The system was washed by repulping and filtered to collect solid matter, which was washed successively with pure water and methanol and dried to give composite copper particles. The resulting composite copper particles were analyzed by XRD. As shown in FIG. 1, peaks assigned to CuSn and Cu₆Sn₅ were observed in the XRD pattern, giving confirmation of the formation of a Cu—Sn alloy. The elemental analysis by ICP revealed that the ratio of tin contained in the composite copper particles was 8.5%.

### Example 2

Tin (II) methanesulfonate as a tin source compound was added to 22.5 L of pure water in an amount of 75.0 g in terms of tin. Ethylenediaminetetraacetic acid (aminocarboxylic acid) was then added thereto as a stabilizer for the tin source in a concentration equal to that of tin. The mixture was stirred at a liquid temperature of 50° C. to dissolve the tin source compound. The solution was adjusted to a pH of 9.6 by adding sodium hydroxide. To the resulting aqueous solution was added an aqueous solution of 37.5 g of sodium boron hydride dissolved in 100 ml of water. Then, 714 g of spherical copper core particles produced by a wet process were dispersed therein. The core particles had an average particle size D₅₀ of 3.29 μm. An aqueous solution of 12.5 g of sodium boron hydride in 100 ml of water was added to the resulting slurry in four divided portions every IS minutes while stirring the slurry. Upon addition of sodium boron hydride, tin-reducing reaction occurred to form a coating layer of a copper-tin alloy on the surface of the copper core particles. The system was washed by repulping and filtered to collect solid matter, which was washed with pure water and methanol and dried to give composite copper particles. As a result of XRD analysis of the composite copper particles, peaks assigned to CuSn and Cu₆Sn₅ were observed, giving confirmation of the formation of a Cu—Sn alloy. The elemental analysis by ICP revealed that the ratio of tin in the composite copper particles was 11.2%.

### Example 3

Tin (II) methanesulfonate as a tin source compound was added to 8.1 L of pure water in an amount of 24.4 g in terms of tin. Ethylenediaminetetraacetic acid (aminocarboxylic acid) was added thereto as a stabilizer for the tin source in a concentration equal to that of tin. The mixture was stirred at a liquid temperature of 50° C. to dissolve the tin source compound. The solution was adjusted to a pH of 9.6 by adding sodium hydroxide. To the resulting aqueous solution was added an aqueous solution of 12.2 g of sodium boron hydride dissolved in 80 ml of water. Then, 775.6 g of spherical copper core particles produced by a wet process were dispersed therein. The core particles had an average particle size D₅₀ of 3.29 μm. An aqueous solution of 4.1 g of sodium boron hydride dissolved in 80 ml of water was added to the resulting slurry in four divided portions every 15 minutes while stirring the slurry. The system was washed by repulping and filtered to collect solid matter, which was washed successively with pure water and methanol and dried to give composite copper particles. As a result of XRD analysis of the composite copper particles, peaks assigned to CuSn and Cu₆Sn₅ were observed, giving confirmation of the formation of a Cu—Sn alloy. The elemental analysis by ICP revealed that the ratio of tin in the composite copper particles was 2.7%.

### Comparative Example 1

Comparative Example 1 corresponds to Example 1 of Patent Literature 1 (JP 2006-225691A). In pure water were dissolved 190 g of tin (II) chloride dihydrate, 1465 g of thiourea, and 1000 g of tartaric acid to make a 10 L solution. The solution was maintained at 40° C. and used as a tin solution for displacement precipitation. Separately, 1 kg of the same core particles as used in Example 1 were stirred in 4 L of pure water maintained at 40° C. to make an aqueous slurry. The tin solution for displacement precipitation was added to the aqueous slurry, followed by stirring for 30 minutes while maintaining the liquid temperature at 40° C. The reaction mixture was worked up in a usual manner by filtration, washing, filtration, and drying to give tin-coated copper particles. As a result of XRD of the resulting tin-coated copper particles, diffraction peaks of copper and tin were observed, but a diffraction peak of a copper-tin alloy was not observed. The ratio of tin contained in the tin-coated copper particles was found to be 5.4% as a result of elemental analysis by ICP.

### Comparative Example 2

Comparative Example 2 corresponds to Example 1 of Patent Literature 2 (JP 2003-342621A), representing preparation of copper particles per se. The copper particles prepared here are those used in Example 1. In water were dissolved 4 kg of copper sulfate (pentahydrate) and 120 g of aminoacetic acid to prepare 8 L of a copper salt aqueous solution at 60° C. While stirring the aqueous solution, 5.75 kg of a 25% sodium hydroxide aqueous solution was added thereto at a constant rate over a period of about 5 minutes, followed by stirring at 60° C. for 60 minutes. The reaction system was aged until the color of the liquid completely turned to black to form copper (II) oxide. After the reaction system was allowed to stand for 30 minutes, 1.5 kg of glucose was added thereto, followed by aging for 1 hour thereby to reduce copper (II) oxide to copper (I) oxide. Subsequently, 1 kg of hydrazine hydrate was added thereto at a constant rate over 5 minutes to reduce copper (I) oxide to give copper powder.

### Evaluation:

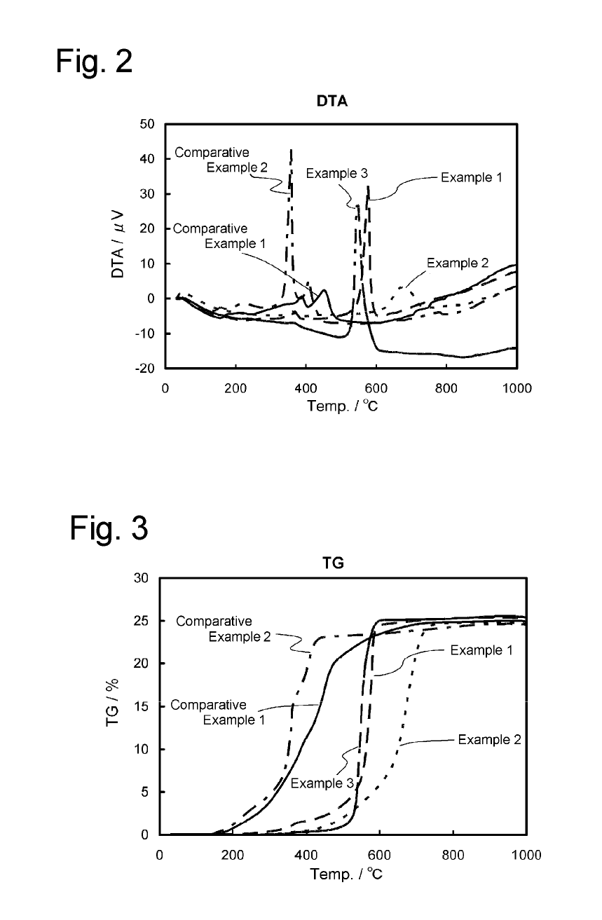

The copper particles obtained in Examples and Comparative Examples were examined in terms of tin ratio in the particles by the method described supra. The particles were also examined for BET specific surface area, tap density, apparent particle size by direct observation, and particle size distribution by the methods described infra. The particles were analyzed by thermogravimetry (TG) and differential thermal analysis (DTA) according to the method described below to obtain the exothermic peak temperature from the results of TG. The results obtained are shown in Table 1 and FIGS. 2 and 3.

### (1) BET Specific Surface Area

A sample weighing 2.00 g was degassed at 75° C. for 10 minutes before measurement. The BET specific surface area was measured by the one-point method for BET method using MonoSorb from Quantachrome Instruments.

### (2) Tap Density

The tap density of a sample weighing 120 g was measured using Powder Tester PT-E from Hosokawa Micron.

### (3) Apparent Particle Size

The apparent particle size was obtained by processing the image of the particles as observed under a scanning electron microscope. “Apparent particle size” is an average particle size calculated from a plan view area of particles so that primary particles are assuredly captured thereby.

### (4) Particle Size Distribution

A sample weighing 0.1 g was mixed with a 0.1% aqueous solution of SN Dispersant 5468 (from San Nopco Ltd.) and dispersed by means of an ultrasonic homogenizer US-300T (from Nihon Seiki Kaisha Ltd.). The particle size distribution was obtained using a laser diffraction scattering particle size analyzer MicroTrac HRA 9320-X100 (from Leeds & Northrup Instruments).

### (5) TG-DTA

A sample was put in a platinum crucible and heated in the atmosphere from room temperature up to 1000° C. at a rate of 10° C./min using TGDTA/Exstar 6000 from Seiko Instruments.

TABLE 1

| | Amount of | | BET Specific | Apparent | Tap | Particle Size | | |
|---|---|---|---|---|---|---|---|---|
| | Coating Tin | Exothermic Peak | Surface Area | Particle Size | Density | Distribution | | |
| | (mass %) | Temperature (° C.) | (m²/g) | (μm) | (g/cm³) | D₁₀ | D₅₀ | D₉₀ |
| Example 1 | 8.5 | 580 | 0.94 | 0.98 | 1.8 | 1.72 | 3.44 | 5.64 |
| Example 2 | 11.2 | 680 | 0.43 | 4.50 | 2.9 | 3.02 | 4.86 | 9.24 |
| Example 3 | 2.7 | 550 | 0.36 | 4.20 | 4.1 | 2.69 | 3.44 | 4.72 |
| Compara. | 5.4 | 450 | 1.32 | 0.89 | 3.6 | 0.80 | 1.07 | 1.53 |
| Example 1 | | | | | | | | |
| Compara. | — | 350 | 0.97 | 0.89 | 3.6 | 0.76 | 0.99 | 1.32 |
| Example 2 | | | | | | | | |

As is apparent from the results in Table 1 and FIGS. 2 and 3, the composite copper particles of Examples (products of the invention) have a higher temperature of the exothermic peak ascribed to the oxidation of copper than the tin-coated copper particles of Comparative Example 1 and the copper particles per se of Comparative Example 2, proving superior in oxidation resistance.

### INDUSTRIAL APPLICABILITY

The composite copper particles of the invention exhibit high oxidation resistance and low electrical resistance even at high temperatures.

1. A composite copper particle comprising a core particle including copper, and a coating layer including a copper-tin alloy and formed on the surface of the core particle, the composite copper particle having a particle diameter at 50% cumulative volume in the particle size distribution of 0.1 to 10.0 μm.

2. The composite copper particle according to claim 1, containing 1.0 to 50.0 mass % of tin.

3. The composite copper particle according to claim 1, wherein the copper-tin alloy is a CuSn alloy, Cu₆Sn₅ alloy, or Cu₃Sn alloy.

4. The composite copper particle according to claim 1, having an exothermic peak ascribed to oxidation of the copper of the core particle at 450° C. or higher in differential thermal analysis conducted in the atmosphere at a rate of temperature rise of 10° C./min.

5. An electrically conductive paste comprising the composite copper particle according to claim 1 and a vehicle.

6. A method for producing composite copper particles comprising a step of mixing a reducing agent for tin and an aqueous slurry containing a tin source compound and core particles which include copper, to form a coating layer comprising a copper-tin alloy on a surface of the core particles.

7. The method according to claim 6, wherein
the tin source compound is a tin (II) compound, and the reducing agent has a reducing power represented by an oxidation-reduction potential of −900 mV or lower at pH 9.0.

8. The method according to claim 7, wherein the reducing agent is sodium boron hydride or potassium boron hydride.

9. The method according to claim 7, wherein the reducing agent is mixed with the aqueous slurry pH of which has been adjusted to 9 to 11.

10. The composite copper particle according to claim 2, wherein the copper-tin alloy is a CuSn alloy, Cu₆Sn₅ alloy, or Cu₃Sn alloy.

11. The composite copper particle according to claim 2, having an exothermic peak ascribed to oxidation of the copper of the core particle at 450° C. or higher in differential thermal analysis conducted in the atmosphere at a rate of temperature rise of 10° C./min.

12. The composite copper particle according to claim 3, having an exothermic peak ascribed to oxidation of the copper of the core particle at 450° C. or higher in differential thermal analysis conducted in the atmosphere at a rate of temperature rise of 10° C./min.

13. An electrically conductive paste comprising the composite copper particle according to claim 2 and a vehicle.

14. An electrically conductive paste comprising the composite copper particle according to claim 3 and a vehicle.

15. An electrically conductive paste comprising the composite copper particle according to claim 4 and a vehicle.

16. The method according to claim 8, wherein the reducing agent is mixed with the aqueous slurry pH of which has been adjusted to 9 to 11.

17. An electrically conductive paste comprising the composite copper particle according to claim 10 and a vehicle.

18. An electrically conductive paste comprising the composite copper particle according to claim 11 and a vehicle.

19. An electrically conductive paste comprising the composite copper particle according to claim 12 and a vehicle.

20. The composite copper particle according to claim 10, having an exothermic peak ascribed to oxidation of the copper of the core particle at 450° C. or higher in differential thermal analysis conducted in the atmosphere at a rate of temperature rise of 10° C./min.
